(19) United States
(12) Patent Application Publication
(10) Pub. No.: US 2019/0207991 A1
(43) Pub. Date: Jul. 4, 2019

(54) METHOD AND DEVICE FOR WIRELESS STREAMING

(71) Applicant: Christopher Jackson, Woodside, NY (US)

(72) Inventor: Christopher Jackson, Woodside, NY (US)

(21) Appl. No.: 16/206,404

(22) Filed: Nov. 30, 2018

Related U.S. Application Data
(60) Provisional application No. 62/593,428, filed on Dec. 1, 2017.

(51) Int. Cl. H04L 29/06

(52) U.S. Cl. CPC H04L 65/4069

(57) ABSTRACT

A wireless mobile streaming device that can be operated using a native codec locally stored on an input device is provided. The wireless mobile streaming device includes a receiver and a transmitter that is configured to communicate with the receiver via a WHDI connection. The wireless mobile streaming device is configured to support video streaming and/or audio streaming. The transmitter uses the native codec locally stored on the input device. A system includes an input device, an output device, and a wireless mobile streaming device. A method of streaming at least one of video content and audio content is also provided. The method includes transmitting at least one of an audio signal and a visual signal based on a native codec locally stored on an input device, and the transmitter is configured to communicate with the receiver via a WHDI connection.

### CROSS-REFERENCE TO RELATED APPLICATION

This application claims the benefit of priority under 35 U.S.C. § 119 to U.S. Provisional Patent Application Ser. No. 62/593,428 as filed on Dec. 1, 2017, the entire content of which is hereby incorporated herein by reference in its entirety for all purposes.

### FIELD OF THE INVENTION

The present disclosure relates generally to a method and device for controlling audio and/or visual media on an output device, such as a television.

### SUMMARY

Aspects and embodiments are directed to devices, systems, and methods for wireless streaming of audio and/or video media.

According to one aspect of the present disclosure, a wireless mobile streaming device includes a receiver configured to communicate with an output device; and a transmitter, the transmitter being configured to receive content from an input device and to communicate with the receiver via a WHDI connection. The wireless mobile streaming device is configured to support at least one of video streaming and audio streaming from the input device to the output device. The transmitter uses a native codec locally stored on the input device.

In some embodiments, the wireless mobile streaming device does not require modification of the locally stored native codec of the input device in order for the wireless mobile streaming device to operate.

In some embodiments, during operation, the transmitter and the receiver meet on a specified channel and exchange a shared key to authenticate the WHDI connection between the transmitter and the receiver.

In some embodiments, the receiver and the transmitter are capable of communicating without having a wi-fi connection between the receiver and the transmitter.

In some embodiments, the WHDI connection operates at 5 GHz.

In some embodiments, the input device is one of a cellular phone and a tablet computer.

In some embodiments, the transmitter is positioned within a housing of a cradle.

According to another aspect of the present disclosure, a method of streaming at least one of video content and audio content from an input device to an output device is provided. In some embodiments, the method includes receiving content from an input device at a transmitter; transmitting the content from the transmitter to a receiver via a WHDI connection; receiving the content at the receiver; and transmitting the content from the receiver to an output device.

In some embodiments, the step of receiving content from the input device comprises receiving the content from a cellular phone. In some embodiments, the step of receiving content from the input device comprises receiving the content from the cellular phone via an HDMI port.

In some embodiments, the WHDI connection operates at 5 GHz.

In some embodiments, the step of transmitting the content from the receiver to the output device comprises transmitting the content to a television.

In some embodiments, the step of transmitting the content from the receiver to the output device comprises transmitting the content to the television via an HDMI port.

In some embodiments, the transmitter uses the native codec locally stored on the input device.

According to one aspect of the present disclosure, a wireless mobile streaming device that can be operated using a native codec locally stored on an input device is provided. The wireless mobile streaming device includes a receiver and a transmitter. The transmitter is configured to communicate with the receiver via a wireless home digital interface (WHDI) connection. The wireless mobile streaming device is configured to support at least one of video streaming and audio streaming. The transmitter uses the native codec locally stored on the input device.

In some embodiments, the wireless mobile streaming device does not require modification of the locally stored codec of the input device in order for the wireless mobile streaming device to operate.

In some embodiments, during operation, the transmitter and the receiver meet on a specified channel and exchange a shared key to authenticate the WHDI connection between the transmitter and the receiver.

In some embodiments, the receiver and the transmitter are capable of communicating without having a wi-fi connection between the receiver and the transmitter.

According to another aspect of the present disclosure, a system includes an input device, an output device, and a wireless mobile streaming device including a transmitter and a receiver. The transmitter is connected to the input device. The transmitter is configured to communicate with the receiver via a WHDI connection. The receiver is connected to the output device. The wireless mobile streaming device is configured to support at least one of video streaming and audio streaming. The transmitter uses a native codec locally stored on the input device.

In some embodiments, the wireless mobile streaming device does not require modification of the native codec locally stored on the input device in order for the wireless mobile streaming device to operate.

In some embodiments, during operation, the transmitter and the receiver meet on a specified channel and exchange a shared key to authenticate the WHDI connection between the transmitter and the receiver.

According to another aspect of the present disclosure, a method of streaming at least one of video content and audio content is provided. The method includes connecting a transmitter to an input device; connecting a receiver to an output device; and transmitting at least one of an audio signal and a visual signal based on a native codec locally stored on the input device, wherein the transmitter is configured to communicate with the receiver via a WHDI connection.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment in any manner consistent with at least one of the objectives, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. Various aspects, embodiments, and implementations discussed herein may also include means for performing any of the recited features or functions.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic of a system for streaming audio and/or video content;

FIG. 2 is a front view of a transmitter and an input device;

FIG. 3 is a front view of an embodiment of a transmitter;

FIG. 4 is a schematic that shows sample dimensions of another embodiment of a transmitter housing;

FIG. 5 is a front view of a receiver;

FIG. 6 is a flowchart of a method of streaming at least one of video content and audio content;

FIG. 7 is a schematic of a system for streaming audio and/or video content;

FIG. 8A is a perspective view of a cellular phone being inserted into a cradle;

FIG. 8B is a perspective view of a cellular phone connected to a television via a transmitter and a receiver;

FIG. 9A is a block diagram of a cradle; and

FIG. 9B is a block diagram of an embodiment of a transmitter and an embodiment of a receiver.

### DETAILED DESCRIPTION

Aspects and embodiments are generally directed to wireless streaming of audio and video media.

The present disclosure provides a system and method for wireless streaming or mirroring. Sometimes, the present disclosure uses the term streaming and mirroring interchangeably. In some embodiments, the system and method allow for content that is displayed on a first device to be mirrored, replicated, or broadcasted on a second device. In some embodiments, there is less than a millisecond delay from when the media content is displayed on the first device to when that media content is displayed on the second device.

The systems and methods of the present disclosure allow any input device (such as a cell phone, tablet computer, or other device) that has a high-definition multimedia interface (HDMI) port to communicate to any output device (such as a television, tablet computer, or other device) that has an HDMI port, without requiring an internet connection or Wi-Fi network. Instead, the systems and methods of the present disclosure rely on a wireless home digital interface (WHDI) connection between a transmitter and a receiver. The transmitter may be connected to the first device via the HDMI port on the first device, and the receiver may be connected to the second device via the HDMI port on the second device. Audio and/or visual media may be mirrored from the first device to the second device via WHDI.

For example, the systems and methods of the present disclosure allow content that is accessible through cellular data on a smartphone or tablet computer to be mirrored on any television that has an HDMI input.

The ability to mirror media from a first device to a second device without requiring an internet connection is advantageous in geographic regions in which there is no internet access. Various countries in the world currently lack access to internet whether by Wi-Fi, ethernet, internet service provider (ISP), or other means, due to a lack of infrastructure. The only form of internet that these countries have is via cellular network and cellular data, which is nearly worldwide. For example, the following countries lack access to internet other than through cellular networks: Guatemala, Honduras, Nicaragua, El Salvador, Senegal, Burkina Faso, Mali, Ghana, Cote d'Ivoire, Benin, Algeria, Libya, Sudan, Eritrea, Ethiopia, Cameroon, Uganda, Rwanda, D.R. Congo, Malawi, Zimbabwe, Zambia, Namibia, Madagascar, Mozambique, Angola, Yemen, Pakistan, Turkmenistan, Nepal, India, Bangladesh, Sri Lanka, Myanmar, and Indonesia. In such regions, customers can use their phone as their internet source to stream audio and video to their televisions. Lack of internet access, such as lack of Wi-Fi, can also affect users in more developed regions.

The systems and methods of the present disclosure provide additional advantages over currently available systems for displaying media on an output device. For example, both Chromecast, available from Google, and Apple TV, available from Apple, communicate via 802.11 b/g/n (2.4 GHz). The maximum data transmission speed of these systems is 2.4 GHz per second. In contrast, the present disclosure provides a system that is capable of transmitting data at 5.2 GHz per second (5 GHz network).

The systems of the present disclosure do not require the user to install a proprietary application on the input device or the output device. Instead, the systems of the present disclosure rely on a WHDI connection between the transmitter and the receiver of the system.

The systems and methods of the present disclosure utilize one or more of the native codecs of the input device to which it connects. Thus, the system is compatible with a wide variety of input devices. For the most part, if the input device is capable of streaming data using a wired HDMI connection, then the input device can stream the data wirelessly using the present system. The native codec stays on the native device and is not replicated or copied in any way, only utilized. In some embodiments, the native codec on the input device may be a codec provided by Google for the Android operating system. For example, the native codec may be MHL or Mobile High-Definition Link. In some embodiments, the native codec on the input device may be a codec provided by Apple. For example, the native codec may be AirPlay.

The transmitter and the receiver of the present disclosure each houses a chipset that utilizes the WHDI frequency to communicate between the transmitter and receiver. Devices like Chromecast require a Wi-Fi connection, which causes hiccups in the transmission of data, and the quality is only as good as the Wi-Fi to which it is connected.

By using a transmitter and a receiver of the present disclosure, an image that is streamed by the transmitter and receiver is as clear at the output device connected to the receiver as what the user sees on his or her input device that is connected to the transmitter. Naturally, if the image that is being streamed is of poor quality, then it will be displayed in the same quality.

Additionally, the system of the present disclosure does not require an electrical cord. Most devices require either the transmitter or receiver (or both) to have a wired power source.

Also, there is no lag associated with the mirroring provided by the system of the present disclosure. The WHDI chipsets in the transmitter and the receiver provide a communication speed that is faster than most (if not all) other devices. With the Chromecast, if a user's Wi-Fi goes out, the user's streaming goes out. If a user's Wi-Fi hiccups, the stream supported on that Wi-Fi hiccups. The system of the present disclosure is independent of any media. Even devices that are not dependent on Wi-Fi use an inferior technology (Bluetooth, etc.).

Nearly every functionality on the phone can be mirrored to the TV. Most other devices only stream data from the internet. This device allows a user to even stream the user's Apple Facetime calls to the user's television, similar to a conference call. All audio and visual data from a mobile device may be mirrored to a television or other display device.

The transmitter may include one or more WHDI antennas. The transmitter may include a commercially available WHDI transmitter chipset. In some embodiments, the WHDI transmitter includes a WHDI chip manufactured by Amimon, which is a member of the WHDI Consortium. The transmitter may include WHDI chipsets other than those described herein. For example, the WHDI chipset may be selected according to the output resolution of the output device. For example, the transmitter may include a WHDI chipset that is compatible with 4K resolution.

In some embodiments, the transmitter is provided in conjunction with a docking station for a cellular phone. In some embodiments, the transmitter is integrated into or otherwise connected to the docking station. In some embodiments, the docking station is configured as a cradle that can support a cellular phone so the screen is visible to a user, so that the user can interact with the screen to select media to be played, adjust volume settings, and/or pause media (such as music or video) that is being played. In some embodiments, the cradle is configured to rest on a horizontal surface while supporting the cellular phone above so that the display screen is within 45 degrees of vertical, within 40 degrees of vertical, within 35 degrees of vertical, within 30 degrees of vertical, within 25 degrees of vertical, within 20 degrees of vertical, within 15 degrees of vertical, within 10 degrees of vertical, or within 5 degrees of vertical. In some embodiments, the cradle is configured to support the cellular phone so that the display screen is substantially upright.

The receiver may include one or more WHDI antennas. The receiver may include a commercially available WHDI receiver chipset. In some embodiments, the WHDI receiver includes a WHDI chip manufactured by Amimon. The receiver of the device may include WHDI chipsets other than those described herein. For example, the WHDI chipset may be selected according to the output resolution of the output device. For example, the receiver may include a WHDI chipset that is compatible with 4K resolution.

According to an aspect of the present disclosure, a system indicated generally at 100 includes an input device 110, an output device 112, and a wireless mobile streaming device indicated generally at 114. The wireless mobile streaming device 114 has a transmitter 116 and a receiver 118. The transmitter 116 is capable of being connected to the input device 110. The receiver 118 is capable of being connected to the output device 112.

In some embodiments, the wireless mobile streaming device 114 is explicitly configured for use with an input device 110 that is a mobile device, such as a smartphone.

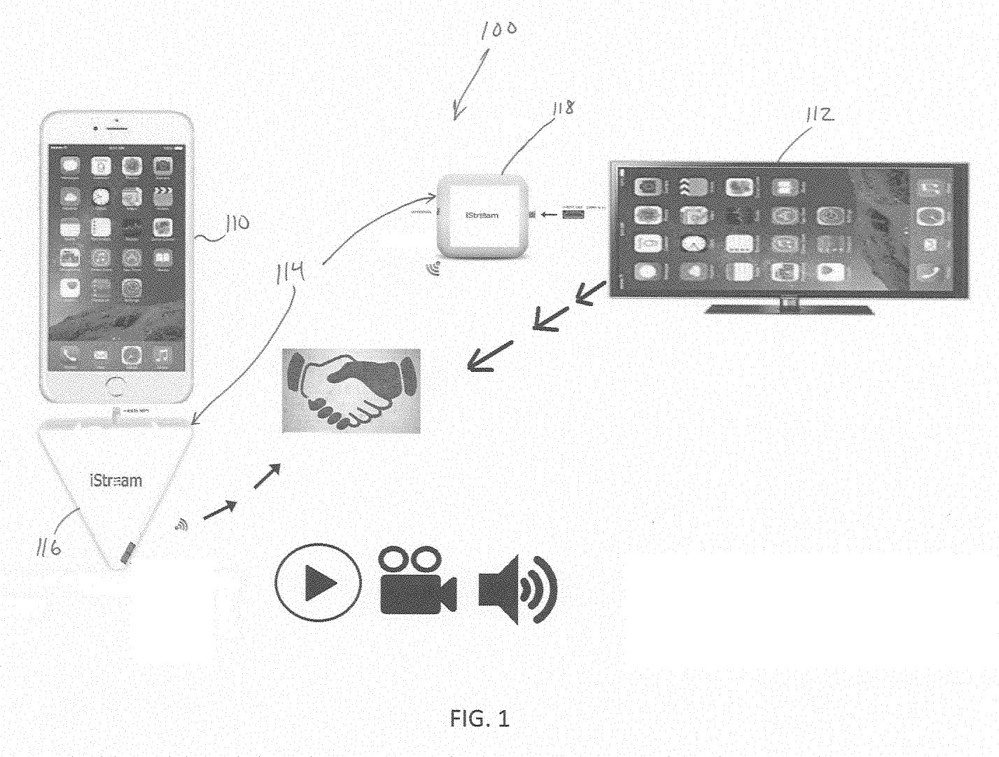

The input device 110 may be a mobile device. The input device 110 can be selected from a smartphone, a tablet computer, a computer, or another device. In FIG. 1, the input device 110 is shown as a smartphone. In some embodiments, the wireless mobile streaming device 114 is compatible with Apple IOS & Android phones and tablets, and the input device 110 is a phone or tablet that has an Apple IOS or an Android operating system.

When connected to the wireless mobile streaming device 114, the input device 110 can be used to remotely control the output of the output device 112 via a wireless home digital interface (WHDI) connection between the transmitter 116 and the receiver 118. WHDI offers several advantages. For example, WHDI is a radio frequency platform that does not require any cellular or internet connection to operate. Additionally, wi-fi is not required by the wireless mobile streaming device 114, nor is entering a passphrase of any kind to connect the transmitter 116 to the receiver 118. The connection between the transmitter 116 and the receiver 118 is established automatically. Another advantage is that the use of WHDI with the wireless mobile streaming device 114 yields a data transfer rate of 5 GHz. Another advantage is that WHDI provides less than a millisecond delay between when the media is accessed on the mobile device and when it is displayed on the television, which means that any application on the input device 110, such as a mobile device, can be enjoyed on the output device 112, such as a TV, without compromising the user-experience.

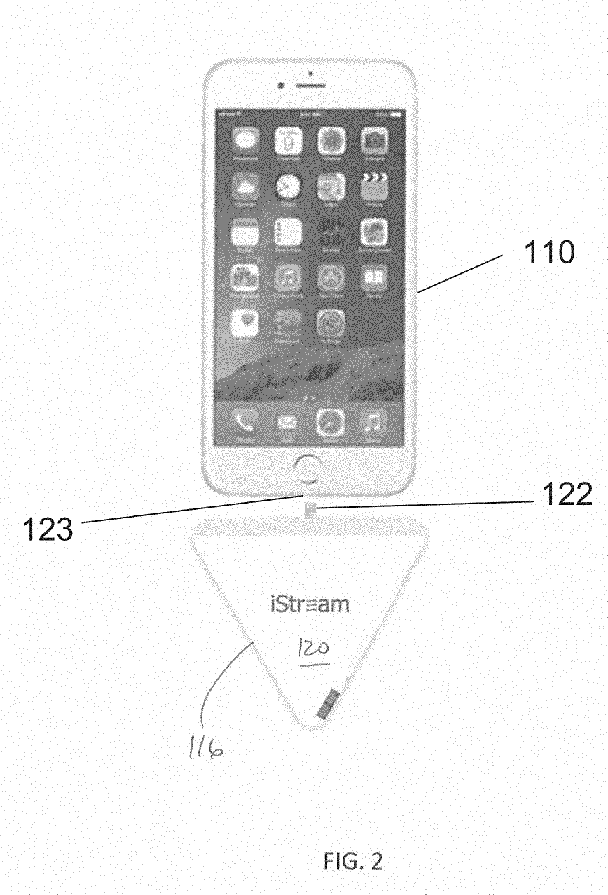

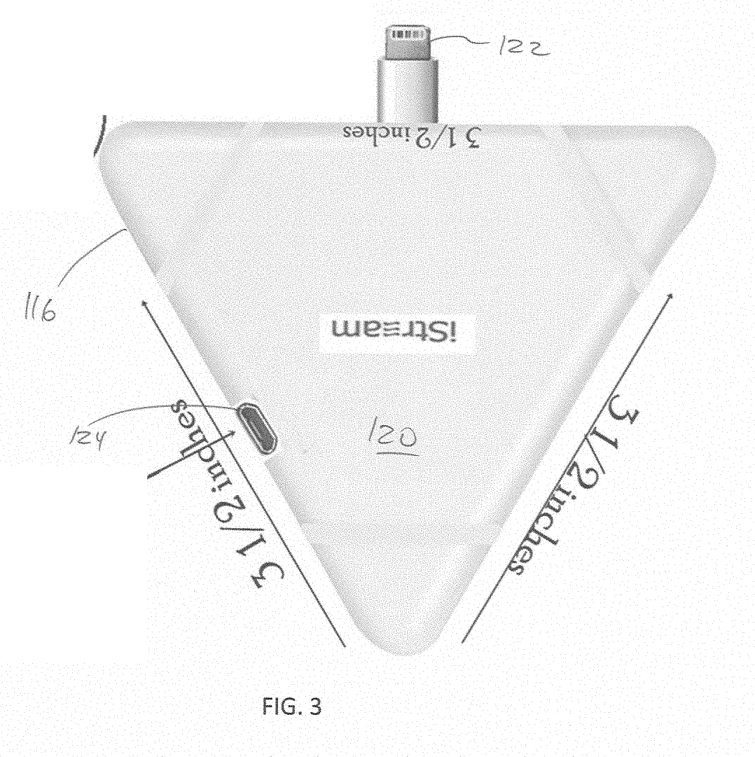

The input device 110 includes a user interface, such as a graphical user interface. A user can operate the input device 110 to select audio content or visual content to be displayed on the output device 112. The audio content and/or visual content may include audio files, image files, video files, or other files that are stored on a memory component of the input device 110. The wireless mobile streaming device 114 is configured to support video streaming and/or audio streaming. In some embodiments, the audio content and/or visual content may include streaming audio content and/or streaming visual content received from a content source that is in communication with the input device 110. The wireless mobile streaming device 114 can be used for office presentations, video conferencing, watching movies, listening to music, and/or streaming any media on an input device 110 to an output device 112 via an HDMI connection from the receiver 118 to the output device 112. The transmitter 116 can be connected to the input device 110. FIGS. 2 and 3 show the transmitter 116 having a transmitter housing 120. In some embodiments, the transmitter connects to the charging port of either an Android or Apple mobile device to communicate with the mobile device. In FIG. 3, a first connector 122 extends beyond the transmitter housing 120, and is useful for connecting the transmitter 116 to the input device 110. In some embodiments, the first connector 122 is a lightning port for connecting to Apple IOS devices.

In FIG. 2, the input device 110 is shown as an Apple iPhone. The transmitter 116 in FIG. 2 is capable of connecting to the input device 110 via a first connector 122 in the form of a lightning connector that can be received in a port indicated at 123 on the input device 110. The first connector 122 of the transmitter 116 may additionally or alternatively include a micro USB connector, so that the transmitter 116 is capable of connecting to other input devices, such as Android devices.

In FIG. 3, the housing 120 of the transmitter 116 is in the shape of a triangle. In some embodiments, each side of the housing 120 has a length of less than 5 inches; in some embodiments, each side of the housing 120 has a length of less than 4 inches; in some embodiments, each side of the housing 120 has a length of about 3.5 inches.

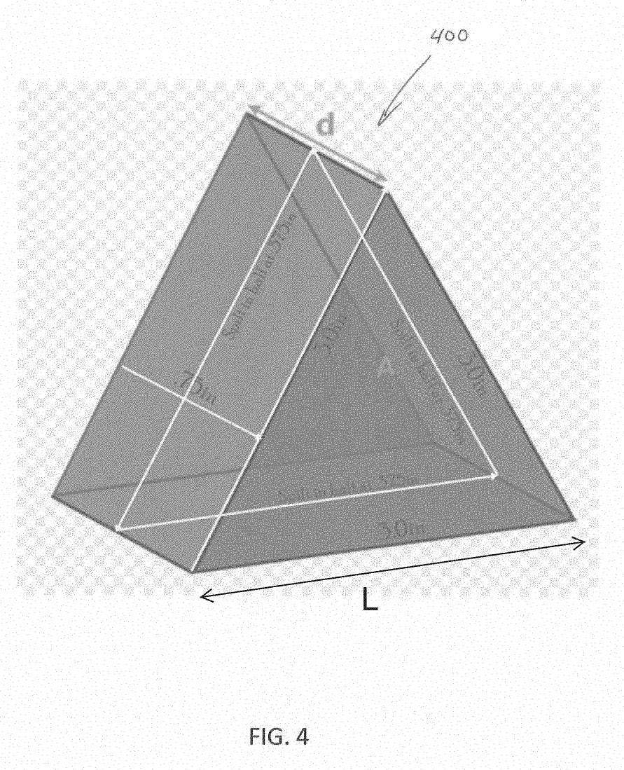

FIG. 4 shows sample dimensions of another embodiment of a transmitter housing 400. In some embodiments, the housing 400 is formed as a clamshell structure. In some embodiments, the depth d of the housing 400 is 0.75 inch, and the length L of each side of the triangular housing 400 is 3 inches.

In some embodiments, the transmitter can include a memory component, a processor, and an internal power supply. In some embodiments, the transmitter is battery powered, and can be recharged using a micro USB cable. In some embodiments, the transmitter can also be charged while it is in use. The transmitter 116 of FIG. 1 includes a charging port 124, such as a USB port for connecting the transmitter to a power source for charging a battery in the transmitter.

The transmitter 116 sends a signal to the receiver 118 so that audio content and/or video content from the input device 110 can be displayed on the output device 112. In some embodiments, the transmitter 116 is configured to communicate with the receiver 118 via a WHDI connection operating at 5 GHz. The wireless mobile streaming device 114 is capable of providing a secure connection between the transmitter 116 and the receiver 118. In some embodiments, during operation of the wireless mobile streaming device 114 of the system 100, the transmitter 116 and receiver 118 meet on a specified channel and exchange a shared key to authenticate the WHDI connection between the transmitter 116 and the receiver 118. There is a digital handshake/connection established between the transmitter 116 and the receiver 118. The digital handshake/connection is facilitated by the WHDI radio frequency transmissions from the transmitter 116 to the receiver 118.

In some embodiments, the receiver 118 is capable of broadcasting its presence to the transmitter 116. In some embodiments, before establishing the handshake, the receiver 118 only broadcasts its presence, and the transmitter 116 connects to the receiver 118 using a shared passphrase or shared key to establish the handshake between the transmitter 116 and the receiver 118. After the handshake is established between the transmitter 116 and the receiver 118, unidirectional traffic flows from the transmitter 116 to the receiver 118, and from the receiver 118 to the output device 112, such as a TV or a liquid-crystal display (LCD) screen, or another display. The transmitter 116 uses a native codec that is locally stored on the input device 110. In some embodiments, the wireless mobile streaming device 114 does not require modification of the native codec that is locally stored on the input device 110 in order for the wireless mobile streaming device 114 to operate. In some embodiments, the native codec is only used by the wireless mobile streaming device 114 when the wireless mobile streaming device 114 is connected to the input device 110. The majority of smart mobile devices, such as smartphones, have a built in HDMI codec explicitly for screen mirroring to external displays. In particular, in some embodiments, the wireless mobile streaming device 114 uses a native locally installed HDMI codec that is provided on an Apple or Android device by Apple or Android, respectively. In some embodiments, the wireless mobile streaming device 114 uses a native locally installed HDMI codec that is provided by another mobile device manufacturer on a mobile device made by the respective mobile device manufacturer. The wireless mobile streaming device provides plug-and-play functionality.

The codec remains on the Apple, Android, or other mobile device and is only utilized when the wireless mobile streaming device 114 is connected to the respective mobile device. The wireless mobile streaming device does not copy, clone or replicate the installed HDMI codec in any way. Nor does the wireless mobile streaming device require installation of a codec in order for the wireless mobile streaming device to operate.

Generally, the native codec on the input device 110 is only activated by a physical device connecting to the charging port of the input device 110 in question. For example Apple and Android both have physical HDMI cables that can be wired to a television activating the codec. The codec ceases operation once the physical connection from the device, such as a television, to the charging port is severed.

The wireless mobile streaming device 114 is more efficient than prior art devices because it eliminates the need for wiring and close proximity streaming. Additionally, the wireless mobile streaming device 114 functions with a self-sufficient authentication system. Manually entering a shared key or passphrase is not necessary when operating the wireless mobile streaming device 114. The established connection between the transmitter 116 and the receiver 118 does not require any human intervention. The initial connection between the transmitter 116 and the receiver 118 and the streaming communication from the transmitter 116 to the receiver 118 occurs at an instantaneous 5 GHz data transfer rate with less than one millisecond delay, setting a new standard for streaming audio and/or video from a mobile device, such as a smartphone, to an output device, such as a television.

The receiver 118 receives the signal from the transmitter 116 via the WHDI connection. The receiver 118 is connected to the output device 112 so the output device 112 can reproduce the content transmitted from the input device 110. In some embodiments, the receiver 118 includes a receiver housing 500.

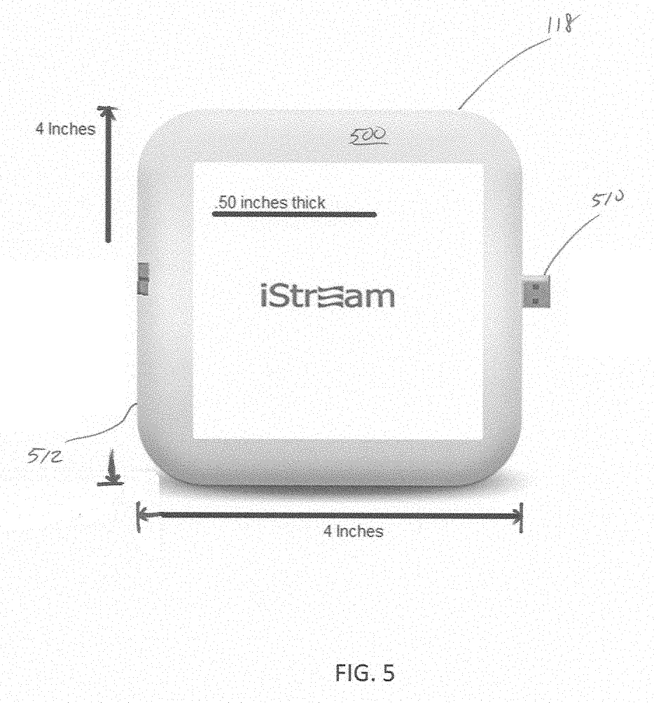

In some embodiments, the receiver can include a memory component, a processor, and an internal power supply. In some embodiments, the receiver 118 is powered by AC power and can be powered over an HDMI cable, such as by a connection to an HDMI port on a television. In some embodiments, the receiver is capable of connecting to any television's HDMI port. FIG. 5 shows a male HDMI connector 510 extending beyond the receiver housing 500 of the receiver 118. FIG. 5 also shows a female USB port 512 on the receiver housing 500 for powering the receiver 118 from an AC power source.

In some embodiments, the receiver housing includes one or more LED indicators for indicating the operation state of the receiver.

The wireless mobile streaming device 114 of the present disclosure does not require a wi-fi connection between the transmitter 116 and the receiver 118. The wireless mobile streaming device 114 of the present disclosure is a plug-and-play device. The wireless mobile streaming device 114 does not require a specific application on the transmitter 116 or the input device 110 in order for the wireless mobile streaming device 114 to operate.

The output device 112 is configured with an audio output and/or a video output. The output device 112 may be a display device. The display device may be a television, a computer monitor, a computer that includes a display, or another device capable of displaying an image. The output device 112 may be an audio device, such as a speaker. In some embodiments, the output device includes an audio output and a video output.

According to an aspect of the present disclosure, the wireless mobile streaming device 114 includes the receiver 118 and the transmitter 116. The transmitter 116 is configured to communicate with the receiver 118 via a WHDI connection. The wireless mobile streaming device 114 is configured to support video streaming and audio streaming separately or simultaneously.

The wireless mobile streaming device 114 can be provided as a set, independently of an input device and/or an output device. A user then connects the transmitter 116 to an input device and connects the receiver 118 to an output device.

The transmitter 116 uses a locally stored codec provided on the input device 110. In some embodiments, the wireless mobile streaming device 114 does not require modification of the native locally stored codec of the input device 110 in order for the wireless mobile streaming device 114 to operate.

In some embodiments, during operation of the wireless mobile streaming device 114, the transmitter 116 and the receiver 118 meet on a specified channel and exchange a shared key to authenticate the WHDI connection between the transmitter 116 and the receiver 118. In some embodiments, this connection is made upon the device powering up and is constant until the devices power down.

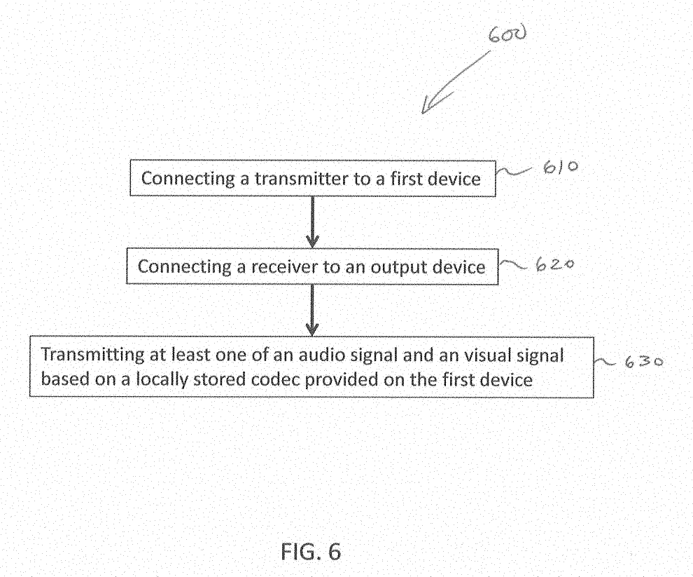

According to another aspect of the present disclosure, a method 600 of streaming at least one of video content and audio content is provided. A method of the present disclosure is shown generally at 600 in FIG. 6. The method 600 includes connecting a transmitter to an input device at block 610. The method includes connecting a receiver to an output device at block 620. The method further includes transmitting at least one of an audio signal and a visual signal based on a locally stored codec provided on the input device at block 630. The transmitter is configured to communicate with the receiver via a WHDI connection. The method 600 can be used in conjunction with any wireless mobile streaming device 114 described above, or with system 100 described above that incorporates a wireless mobile streaming device 114.

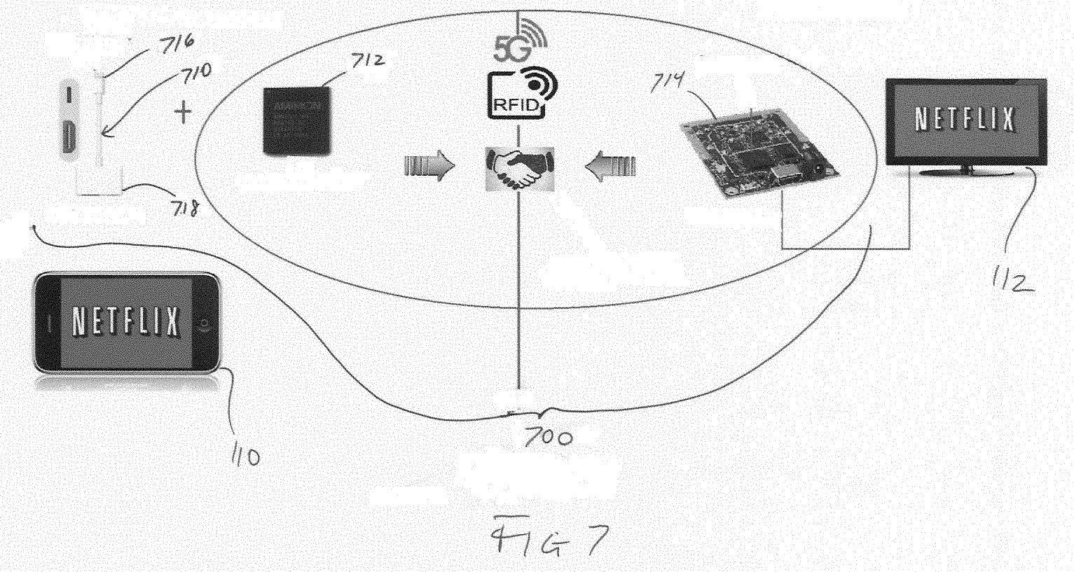

FIG. 7 is a schematic of a system for streaming audio and/or video content. While the transmitter and receiver housing are not shown, the general components of the system are shown. The system 700 can be used to connect an input device 110 to an output device 112. The system 700 includes an input converter 710, a WHDI transmitter chipset 712, and a WHDI receiver chipset 714.

The input converter 710 is useful for connecting a port on input device, such as a phone, to an HDMI port on a transmitter (not shown). The input converter 710 connects to the port on the input device via an input connector 716. The input connector 716 is in communication with an HDMI connector 718 on the input converter 710. The HDMI connector 718 may be connected to a transmitter that has an HDMI port. In some embodiments, the HDMI connector 718 may be connected via an HDMI cable to a transmitter that has an HDMI port.

The input converter 710 is shown as a converter for use with an Apple iPhone. The input connector 716 is configured as a male connector for use with an Apple lightning port. In other embodiments, the input connector 716 is configured as a micro USB connector, or another connector.

To transmit media displayed on the phone to a receiver, the WHDI transmitter chipset 712 is in communication with the HDMI connector 718. In FIG. 7, the transmitter chipset is shown as a chipset manufactured by Amimon. In other embodiments, other chipsets are used.

In some embodiments, the WHDI transmitter chip set 712 is capable of transmitting a signal via WHDI a distance of at least 10 feet. In some embodiments, the WHDI transmitter chipset 712 is capable of transmitting a signal via WHDI a distance of at least 20 feet. In some embodiments, the WHDI transmitter chipset 712 is capable of transmitting a signal via WHDI a distance of about 30 feet. In some embodiments, the WHDI transmitter chipset 712 is capable of transmitting a signal via WHDI a distance of 30 meters.

To receive the media at the output device, a receiver includes the WHDI receiver chipset 714. In FIG. 7, the WHDI receiver chipset 714 is manufactured by Amimon. In other embodiments, another WHDI receiver chipset may be used.

The WHDI receiver chipset 714 may be connected to an output device 112 via an HDMI cable.

In some nonlimiting embodiments, the transmitter is in the form of a cradle. In some embodiments, the cradle is configured to be a support structure that rests on a desk or other surface. In some embodiments, the cradle is configured to be handheld, should the user need to interact with their phone to present slides while delivering a presentation.

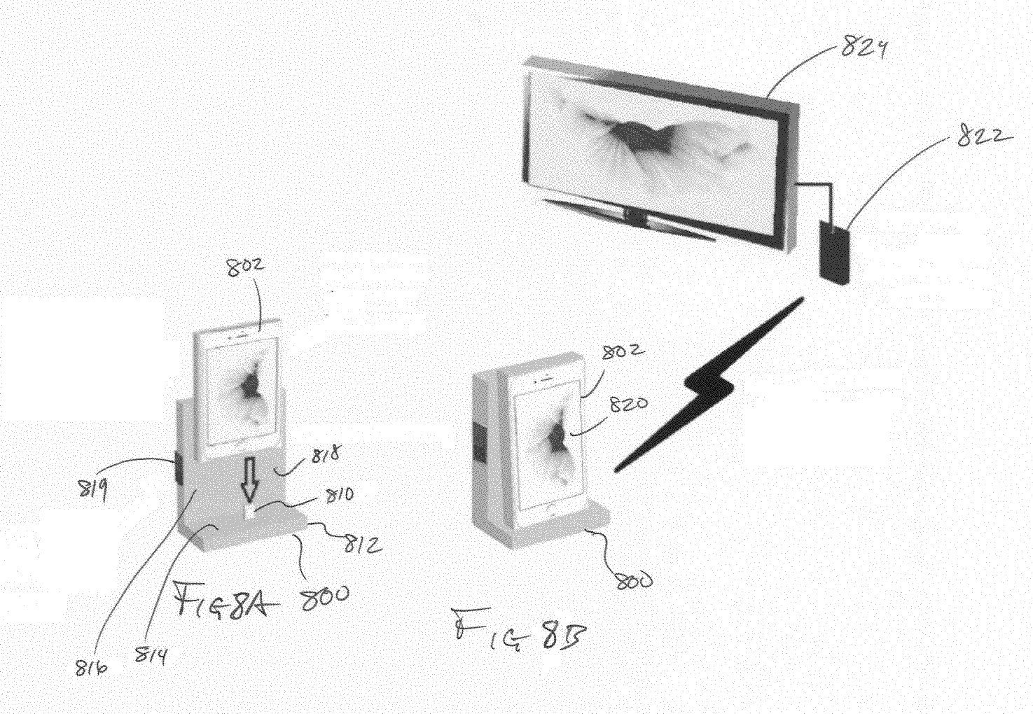

FIG. 8A shows a cradle 800 that houses a transmitter. The cradle includes an input connector 810 for connecting to an input device, such as a cellular phone. The input connector 810 may be a lighting connector, a micro USB connector, or another connector. The cradle includes a bottom wall 812 having an upper surface 814 for supporting an input device. In some embodiments, the input device rests directly against the upper surface 814 when the input device receives the input connector 810. The cradle also includes a vertical wall 816 that has a front surface 818. In some embodiments, the front surface 818 of the vertical wall directly engages the input device when the input device is connected to the input connector 810.

The cradle 800 may be configured to snugly support the input device 802 so that a user can view the display screen 820 of the input device 802 when the input device 802 is connected to the input connector 810, as shown in FIG. 8B.

The cradle 800 includes a user interface 819 on a surface of the cradle, so that a user can monitor the functionality of the cradle. In some embodiments, the user interface 819 is a display screen. In some embodiments, the user interface 819 is a touch screen. The user interface 819 may be used to show the charge of a battery of the cradle, the WHDI connection status with the receiver, the status of the connection of the cradle to the input device, and/or other information.

A WHDI transmitter is included within the cradle 800. The transmitter streams data using a WHDI frequency, such as 5 GHz to a receiver 822. The receiver 822 connects to an output device 824, such as a television via an HDMI cable. In this way, media is communicated from the input device 802 to the transmitter, then transmitted via WHDI to the receiver 822, and then communicated from the receiver 822 to the output device 824.

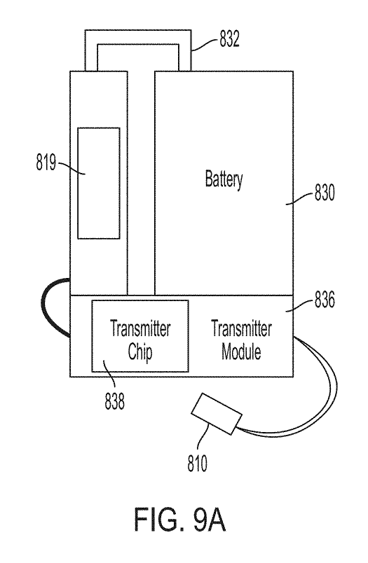

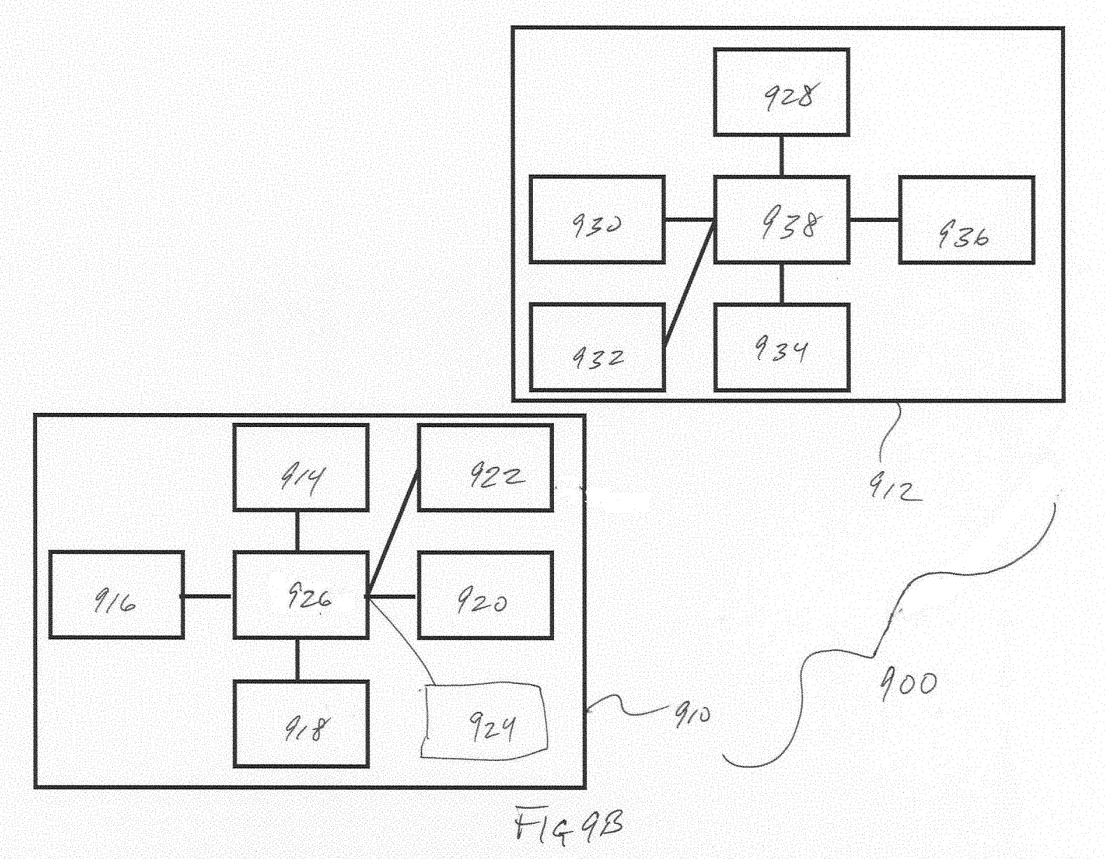

FIG. 9A is a block diagram of an embodiment of a transmitter cradle. The cradle includes a battery 830 that is connected by leads 832 to the interface 819 and a transmitter module 836. The transmitter module 836 includes a transmitter chip 838. In some embodiments, the transmitter chip 838 is capable of transmitting a WHDI signal. The transmitter chip 838 is connected to the interface 819. The transmitter module 836 is connected to the input connector 810.

FIG. 9B is a block diagram of an embodiment of a pair 900 of a transmitter 910 and a receiver 912 according to the present disclosure in which various aspects and functions discussed above may be practiced. For example, in some embodiments the transmitter 116 in FIG. 1 can include any of the components shown in the transmitter 910 of FIG. 9B and/or the receiver 118 of FIG. 1 can include any of the components of the receiver 912 of FIG. 9B.

The transmitter 910 includes a memory 914, an interface 916, a processor 918 (e.g., a single core or a multi-core processor), and storage 920, an antenna 922, and a display 924, which are all connected to an interconnection element (a bus) 926.

The interface 916 may receive input, provide output, or both.

The memory 914 and/or storage 920 may be used for storing programs and data during operation of the transmitter 910. For example, the memory 914 may be a relatively high performance, volatile, random access memory such as a dynamic random access memory (DRAM) or static memory (SRAM). In addition, the memory 914 may include any device for storing data, such as a disk drive or other non-volatile storage device, such as flash memory, solid state, or phase-change memory (PCM). The storage 920 may include a computer-readable and computer-writeable nonvolatile storage medium in which instructions are stored that define a program to be executed by the processor. The storage system 920 also may include information that is recorded, on or in, the medium, and this information may be processed by an application. A medium that can be used with various embodiments may include, for example, optical disk, magnetic disk or flash memory, SSD, among others. Further, aspects and embodiments are not to a particular memory system or storage system.

In some embodiments, the transmitter 910 may include an operating system that manages at least a portion of the hardware components (e.g., input/output devices, touch screens, cameras, etc.) included in the transmitter. One or more processors or controllers, such as processor 918, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The receiver 912 includes a memory 928, an interface 930, a processor 932 (e.g., a single core or a multi-core processor), and storage 934 and an antenna 936, which are all connected to an interconnection element (a bus) 938.

The interface 930 may receive input, provide output, or both.

The memory 928 and/or storage 934 may be used for storing programs and data during operation of the receiver 912. For example, the memory 928 may be a relatively high performance, volatile, random access memory such as a dynamic random access memory (DRAM) or static memory (SRAM). In addition, the memory 928 may include any device for storing data, such as a disk drive or other non-volatile storage device, such as flash memory, solid state, or phase-change memory (PCM). The storage 934 may include a computer-readable and computer-writeable nonvolatile storage medium in which instructions are stored that define a program to be executed by the processor. The storage system 934 also may include information that is recorded, on or in, the medium, and this information may be processed by an application. A medium that can be used with various embodiments may include, for example, optical disk, magnetic disk or flash memory, SSD, among others. Further, aspects and embodiments are not to a particular memory system or storage system.

In some embodiments, the receiver 912 may include an operating system that manages at least a portion of the hardware components (e.g., input/output devices, touch screens, cameras, etc.) included in the transmitter. One or more processors or controllers, such as processor 932, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The antennas 922, 936 communicate via a WHDI connection.

### Example

In one nonlimiting example, a system according to the present disclosure includes at least the following specifications:

Output: HDMI

Processor: AMIMON AMN 2120

RAM: 512 MB

Storage: 512 MB flash

Max. Output Video Resolution: 1080p

Connectivity: WHDI/RF 5 GHz

Power: microUSB (Power adapter included)

Max data transmission speed 5.2 ghz per second

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A wireless mobile streaming device, comprising:
a receiver configured to communicate with an output device; and
a transmitter, the transmitter being configured to receive content from an input device and to communicate with the receiver via a WHDI connection,
wherein the wireless mobile streaming device is configured to support at least one of video streaming and audio streaming from the input device to the output device, and
wherein the transmitter uses a native codec locally stored on the input device.

2. The wireless mobile streaming device of claim 1, wherein the wireless mobile streaming device does not require modification of the native codec of the input device in order for the wireless mobile streaming device to operate.

3. The wireless mobile streaming device of claim 1, wherein, during operation, the transmitter and the receiver meet on a specified channel and exchange a shared key to authenticate the WHDI connection between the transmitter and the receiver.

4. The wireless mobile streaming device of claim 1, wherein the receiver and the transmitter are capable of communicating without having a wi-fi connection between the receiver and the transmitter.

5. The wireless mobile streaming device of claim 1, wherein the WHDI connection operates at 5 GHz.

6. The wireless mobile streaming device of claim 1, wherein the input device is one of a cellular phone and a tablet computer.

7. The wireless mobile streaming device of claim 1, wherein the transmitter is positioned within a housing of a cradle.

8. A method of streaming at least one of video content and audio content from an input device to an output device, the method comprising:
receiving content from an input device at a transmitter;
transmitting the content from the transmitter to a receiver via a WHDI connection;
receiving the content at the receiver; and
transmitting the content from the receiver to an output device.

9. The method of claim 8, wherein the step of receiving content from the input device comprises receiving the content from a cellular phone.

10. The method of claim 9, wherein the step of receiving content from the input device comprises receiving the content from the cellular phone via an HDMI port.

11. The method of claim 9, wherein the WHDI connection operates at 5 GHz.

12. The method of claim 8, wherein the step of transmitting the content from the receiver to the output device comprises transmitting the content to a television.

13. The method of claim 12, wherein the step of transmitting the content from the receiver to the output device comprises transmitting the content to the television via an HDMI port.

14. The method of claim 8, wherein the transmitter uses the native codec locally stored on the input device.
